(19) United States
(12) Patent Application Publication
(10) Pub. No.: US 2009/0173847 A1
(43) Pub. Date: Jul. 9, 2009

(54) Accessory Holder

(76) Inventors: Wolfgang Dittmer, Guilford, CT (US); Aaron Tsui, Brooklyn, NY (US); Bradley Augustine, Brooklyn, NY (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(21) Appl. No.: 12/347,686

(22) Filed: Dec. 31, 2008

Related U.S. Application Data
(63) Continuation-in-part of application No. 11/626,553, filed on Jan. 24, 2007.
(60) Provisional application No. 61/059,884, filed on Jun. 9, 2008.

(51) Int. Cl. F16M 11/38; F16M 11/24

(52) U.S. Cl. 248/125.2; 248/125.1

(57) ABSTRACT

The present invention is directed to an accessory holder capable of supporting a plurality of accessories and positioning those accessories in three-dimensions. A preferred embodiment supports the accessories in a curvilinear shape that optimizes the viewing position by the user. The accessories include flat panel displays, touch screens, telephones, and other devices used in an office or home office environment.

### I. CROSS-REFERENCE TO RELATED APPLICATION

This application is a continuation-in-part of, and claims the priority benefit of, U.S. Ser. application No. 11/626,553, filed Jan. 24, 2007, and U.S. Serial Application No. 61/059,884, filed Jun. 9, 2008, each of which is hereby incorporated by reference herein in its entirety.

### II. STATEMENT REGARDING FEDERALLY SPONSORED RESEARCH OR DEVELOPMENT

Not Applicable.

### III. THE NAMES OF THE PARTIES TO A JOINT RESEARCH AGREEMENT

Not Applicable.

### IV. INCORPORATION-BY-REFERENCE OF MATERIAL SUBMITTED ON A COMPACT DISC

Not Applicable.

### V. BACKGROUND

A. Field of the Invention

The present invention is generally directed to mechanisms useful for facilitating the support and positional adjustment of an attached device. More particularly, the invention provides a position adjustable accessory holder for use with an input device or a display device, such as a video display. The accessory holder allows for easy three-dimensional adjustment of a device to place the device in a position more ergonomically desirable for a user.

B. Background Art

As more individuals spend an increasing amount of time using computers, computer users are sitting at desks or workstations in front of input/output devices such as video displays for longer periods of time. This time encompasses performing activities that include inputting data, viewing video display, and otherwise interacting with digital media.

The increasing amount of time associated with such activity has been associated with various health problems. These problems include muscle strain, fatigue, and stress caused by improper posture. According to experts in ergonomics, though, there are several easy and effective ways in which computer users can improve their physical comfort, fight fatigue, and reduce the risk of injuries from repetitive motions.

Posture is one area in which minor adjustments can quickly yield benefits. At home, but especially in a more stressful environment, like an office, users may force their bodies into rigid positions that result in fatigue, muscle strain, and, potentially, injury. Maintaining what experts refer to as optimal ergonomic positioning can increase energy levels and improve overall comfort. Good posture keeps the spine in what health professionals call the neutral position. Achieving a neutral posture while seated upright in a chair with good lumbar support entails lifting the rib cage away from the hips, tucking in the stomach, pulling the shoulders back, centering the weight of the head atop the spine, and maintaining the lower back in a gentle C-shaped curve. Sustaining this position can help reduce muscle strain and relieve pressure on the lower back.

Beyond spinal posture, optimal ergonomic positioning requires tailoring the work area to fit the user's needs. Among things necessary to accomplish that is to position video displays in appropriate positions. Having the video displays in proper positions reduces muscle strain caused by the weight of the head leaning too far backward or forward.

The prior art discloses multiple methods for positioning video displays. U.S. Pat. No. 6,149,253 discloses a system comprising a display platform supported on a frame with a lift actuator, the display platform having a swivel base, a swivel actuator, a tilt actuator, and a display table. Systems such as this, while functional, are inefficient and bulky. Further, such systems are limited to use with larger displays, such as conventional computer monitors and conventional CRT television sets.

The present state of the art in video display has an emphasis on flat screen designs. This conforms to the market demand for higher performance, less space consumption, and a more streamlined appearance. To meet this demand, it is becoming common to have flat screen video displays attached to a work area with some manner of display arm. These prior art display arms cannot hold a plurality of video displays and consequently are not able to keep a plurality of videos displays in optimal position. In other embodiments, a plurality of display arms may be supported but they are not maintained in optimal positions and result in discomfort to the user. Furthermore, the daily needs of individual users can also change. To be ergonomically beneficial, a video display should be capable of three-dimensional adjustment to a most comfortable position. None of the prior art systems can support numerous accessories in optimal positions and be adjusted in three dimensions.

### VI. BRIEF SUMMARY OF THE INVENTION

The invention is an accessory holder comprising a vertical support, a height adjustment means comprising a left support arm and a right support arm operatively engaged to the vertical support, a first track attached to left support arm and the right support arm, the first track comprising at least two shaft mounts attached to the first track at locations approximately equidistant from the center of the first track, at least two vertical shafts, each vertical shaft releasably secured to one shaft mount of the first track, and each vertical shaft capable of receiving one or more additional tracks; at least one additional track comprising at least two shaft mounts, each shaft mount operatively engaged with each vertical shaft, such that the first track and the one or more additional tracks are capable of relative height adjustment; and at least one support attachment bracket slidably attached to the track; the support attachment bracket being adapted to removably attach to an accessory.

In another embodiment, the vertical support comprises a mounting means. In yet another embodiment, the height adjustment means further comprises a height controller; wherein the left support arm and the right support arm each extend outward from the vertical support and are attached to the track, and wherein the height of the left and right support arms is controlled by the height controller.

In another embodiment, the height adjustment means further comprises a sleeve surrounding the vertical support, the sleeve being capable of rotating around the vertical support, the sleeve being operably engaged to the height controller. The left and right support arms may each comprise an tipper arm extending substantially horizontally from the sleeve to a distal end; and a lower arm extending from the sleeve at an upward angle to an intersection with the upper arm.

In some embodiments of the present invention, one shaft mount of the first track attaches the first track to the intersection of the lower arm and the distal end of the upper arm of the left support arm and another shaft mount of the first track attached the first track to the intersection of the lower arm and the distal end of the upper arm of the right support arm. Alternatively, the first track may be attached to the intersection of the upper arm and the lower arm of the right support arm separate from the shaft mounts of the first track, and the first track may be attached to the intersection of the upper arm and the lower arm of the left support arm separate from shaft mounts of the first track.

In another embodiment of the present invention, the first track comprises: a central track attached to the height adjustment means; and at least one wing track pivotally attached to a distal end of the central track. The wing track may be pivotally attached to a distal end of the central track such that the wing track pivots up to 180 degrees in the same plane as the central track. The wing track may also be pivotally attached to a distal end of the central track such that the wing track pivots up to 90 degrees in a plane perpendicular to the central track.

In some embodiments, the accessory holder of the present invention comprises one or more power or data connections that engage the support attachment bracket and an outside source of power or data, such that the connections are adapted to provide power or data to the accessory.

In yet another embodiment of the present invention, the shaft mount comprises a shaft sleeve attached at the intersection of the upper arm and the lower arm of each of the left support arm and the right support arm. The shaft mount may further comprise a shaft sleeve and a locking means for adjusting the relative height between the first track and the one or more additional tracks, the vertical shafts being operatively engaged within the shaft sleeve and releasably secured to the shaft sleeve by the locking means.

In one embodiment of the present invention, the height controller comprises a gear rack attached to the vertical support; at least one gear operatively engaged with the gear rack; and a handle attached to the at least one gear, wherein rotating the handle rotates the at least one gear. The height controller may also comprises a gear rack attached to the vertical support; at least one gear operatively engaged with the gear rack; and a motor attached to the at least one gear, wherein rotating the motor rotates the at least one gear. Alternatively, the height controller comprises a housing supporting a gear rack along its length; a skate slidably attached to the housing; at least one gas cylinder attached to the skate; at least one gas cylinder actuator attached to the at least one gas cylinder; a gear box having at least one gear operatively engaged to the gear rack, the gear box attached to the skate; and a knob attached to the at least one gear.

In another embodiment of the present invention, the mounting means may comprise a wall mount, the wall mount having a plate through which mechanical fasteners can be inserted into a wall. The mounting means could also comprise: a receiving member attached to a desk and adapted to receive a connecting member; and a connecting member attached to the height adjustment means. Alternatively, the mounting means comprises a mounting plate attached to the vertical support and a wall track attached to a wall, the wall track adapted to be removably attached to the mounting plate. The mounting means may also comprise a desk mount, the desk mount comprising: a desktop; a receiving member attached to the desk and adapted to receive a connecting member; and a connecting member attached to the height adjustment means.

In one embodiment of the present invention, an accessory holder comprises a mount attached to a structure; a base attached to the mount; a substantially circular cylinder attached to the base at a proximal end, the circular cylinder having a distal end; a gear rack along the vertical length of the substantially circular cylinder; a hand crank housing movably attached to the substantially circular cylinder; a gear movably attached to the hand crank housing and operably engaged with the gear rack; a handle attached to the gear; two support arms attached at a proximal end to the substantially circular cylinder, the support arms extending outward from the substantially circular cylinder, the support arms having distal ends; a central track attached to the distal ends of the support arms, the central track being curvilinear, the central track further comprising at least two shaft mounts; at least one wing track pivotally attached to a distal end of the central track; at least two vertical shafts, each vertical shaft being operatively engaged through each shaft mount; one or more additional tracks, each additional track comprising at least two shaft mounts operatively engaged with the at least two vertical shafts; and at least one support attachment bracket adapted to be removably attached to an accessory, the support attachment bracket slidably attached to one of the central track and the wing track. The wing track may be pivotally attached to a distal end of the central track such that the wing track pivots up to 180 degrees in the same plane as the central track. The wing track may be pivotally attached to a distal end of the central track such that the wing track pivots up to 90 degrees in a plane perpendicular to the central track. The accessory holder may further comprise one or more power or data connections that engage the support attachment bracket and an outside source of power or data, such that the connections are adapted to provide power or data to the accessory.

In another embodiment, the shaft mount of the present invention may comprise a locking means, the locking means releasably securing the vertical shaft to the shaft mount, such that the relative distance between the one or more additional tracks and the central track may be adjusted by a user.

In yet another embodiment, the accessory holder of the present invention comprises a vertical support; a height adjustment means comprising a left support arm and a right support arm operatively engaged to the vertical support; at least one track attached to left support arm and the right support arm; at least two vertical shafts operatively engaged with the track and capable of supporting one or more additional tracks in operative engagement with the vertical shafts such that the relative height between the track and the one or more additional tracks may be adjusted along the vertical shafts; and at least one support attachment bracket slidably attached to the track; the support attachment bracket being adapted to removably attach to an accessory; wherein each of the vertical support, the left support arm, the right support arm, the track, and the support attachment bracket are operably engaged when in use.

The above summary of the present invention is not intended to describe each illustrated embodiment or every possible implementation of the present invention. The figures and the detailed description which follow, however, do particularly exemplify these embodiments.

### VII. BRIEF DESCRIPTION OF THE SEVERAL VIEWS OF THE DRAWINGS

In consideration of the following detailed description of various embodiments, the invention may be more completely understood in connection with the following drawings.

FIG. 1 is an illustration showing a side view of one embodiment of the invention.

FIG. 2 is an illustration showing a rear view of one embodiment of the invention.

FIG. 3 is a blown up view of a track in an embodiment of the invention.

FIG. 4 is a rear view of one embodiment of the invention.

FIG. 5 is an exploded front view of a track and attachments used in one embodiment of the invention.

FIG. 6 is a top view of one embodiment of the invention.

FIG. 7 is an illustration showing a side view of one embodiment of the invention.

FIG. 8 is an illustration showing a side view of another embodiment of the invention.

FIG. 9 is an illustration showing a rear view of another embodiment of the invention.

FIG. 10 is a rear view of another embodiment of the invention.

FIG. 11 is an exploded front view of a track and attachments used in one embodiment of the invention.

FIG. 12 is a top view of another embodiment of the invention.

FIG. 13 is an illustration showing a side view of one embodiment of the invention.

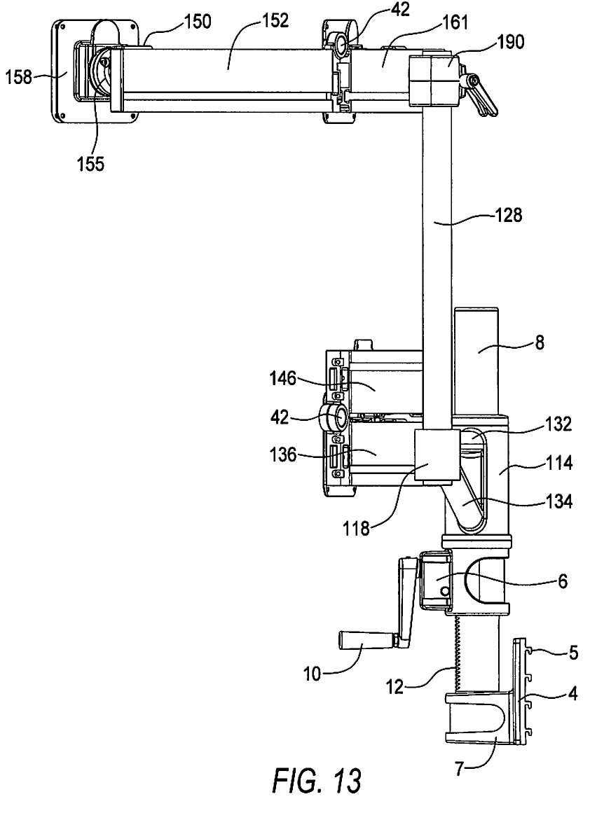

While the invention is amenable to various modifications and alternative forms, specifics thereof have been shown by way of example in the drawings and will be described in detail such that the disclosure will be thorough and complete, and will fully convey the scope of the invention to those skilled in the art. It should be understood, however, that the intention is not to limit the invention to the particular embodiments described. On the contrary, the intention is to cover all modifications, equivalents, and alternatives falling within the spirit and scope of the invention as defined by the appended claims.

### VIII. DETAILED DESCRIPTION OF THE INVENTION

The present invention provides an accessory holder generally useful for facilitating positional adjustment and support of a variety of attached devices. The inventive mechanisms are particularly useful for positional adjustment and support of different devices associated with electronic media input and output. In one embodiment, a display device, such as a video display (e.g., a flat-screen monitor), can be attached to the inventive accessory holder. In further embodiments, input devices, such as a touch screen, can be attached to the accessory holder. Further, the accessory holders are useful for attachment thereto of a support, such as for supporting a computer keyboard, a laptop computer, a personal DVD player, document holder, or other input, display, or combination device.

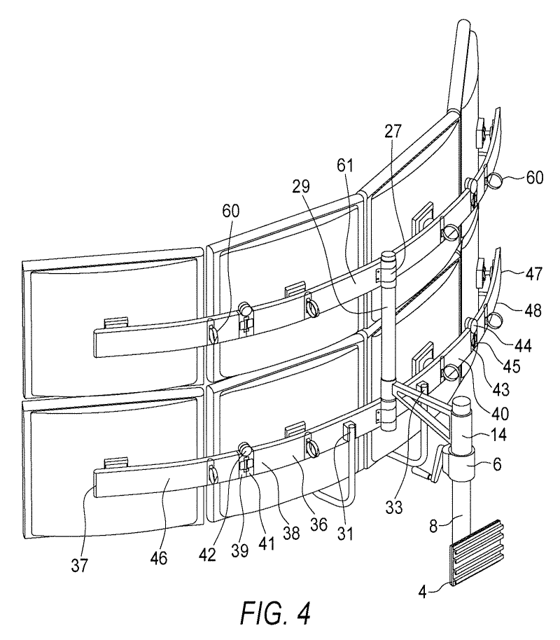

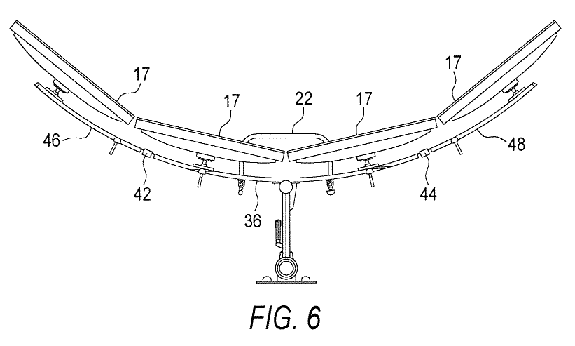

For simplicity, the invention will be described in terms of allowing for positional adjustment and support of a plurality of flat screen monitors 17 (see FIGS. 4, 6, 10 and 12). Accordingly, any description of the accessory holder in terms of positional adjustment or support of a flat screen monitor is not intended to be limiting to specific devices but is rather intended to generally describe the ability of the accessory holder of the invention to be used with a wide variety of devices.

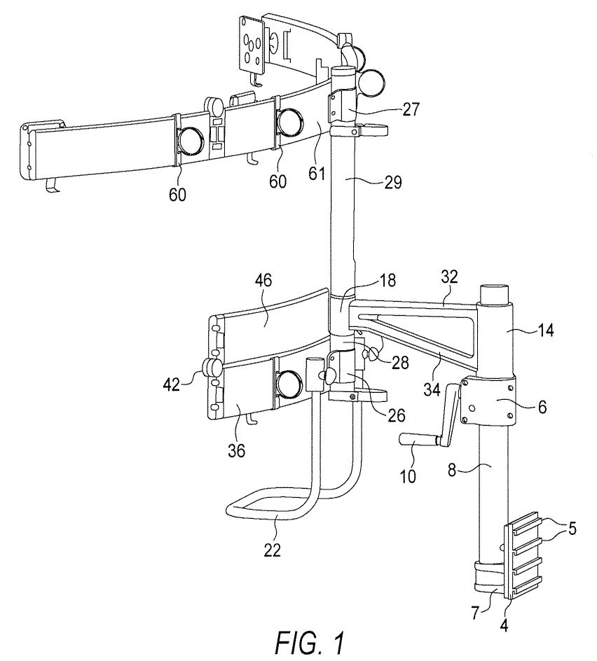

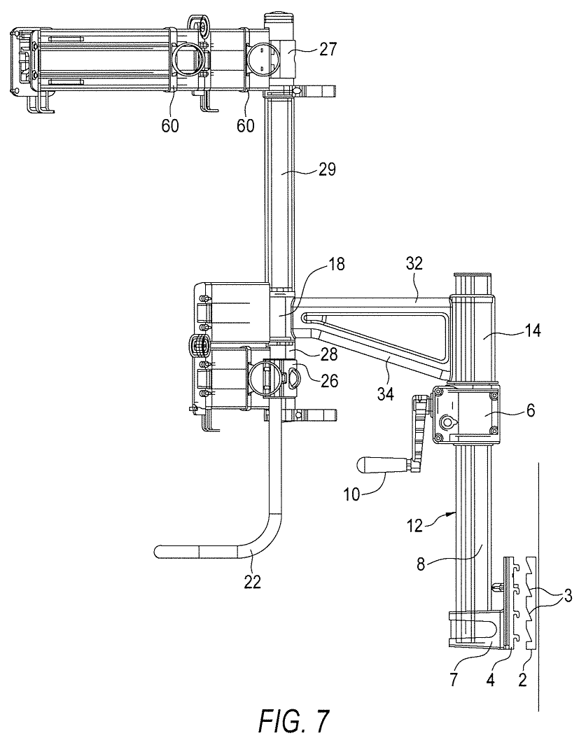

Typically, these types of accessory holders are positioned above desks in an office or home office environment. The accessory holder will be mounted to a wall, a track mounted on a wall, the desk, or some other structurally secure object. FIGS. 1 and 7 are illustrations of a first embodiment of the accessory holder. In this first embodiment, the accessory holder is mounted to a track attached to a wall. Specifically, a wall track 2 (see FIG. 7) is mounted to a wall and mounting plate 4 is attached to wall track 2. Preferably, the wall track 2 is approximately three-quarters inches in depth and has horizontal channels 3 along its length. It is preferably bolted to a wall. The mounting plate 4 is preferably flat on one side and has horizontal ribs 5 on the opposite side. These horizontal ribs 5 are positioned and dimensioned to be received by the horizontal channels 3 in the wall track 2 when the mounting plate 4 is attached. These ribs 5 provide additional support for the accessory holder. The mounting plate 4 can be fastened to the wall track 2 by any known fastening means of sufficient strength (e.g., screws or bolts). In an alternative embodiment, the mounting plate 4 just clips to the wall track 2 using a bracket (e.g., “L” shaped bracket). This embodiment may be realized by the horizontal channels 3 having a ridge that is received by a channel in the underside of the ribs 5, thereby allowing the mounting plate to be clipped on the track 2. Preferably, in this embodiment, the “L” shaped bracket may be adjusted to grip the horizontal channel 3 to prevent any movement of the mounting plate 4 relative to the wall track 2. In another embodiment, the wall track is not used and the mounting plate is secured to the wall directly.

Referring still to the embodiment shown in FIG. 7, base 7 is attached to mounting plate 4. Preferably, base 7 is constructed of metal and is cylindrical in shape. Base 7 may be adapted to receive vertical pole 8, which may be frictionally secured in place. Vertical pole 8 is connected to base 7 at a proximal end and extends upward to a distal end. The vertical pole 8 is preferably constructed of metal and is cylindrical in shape. A gear rack 12 is attached to the vertical pole 8 and extends along its length from the proximal end to the distal end. The gear rack 12 is preferably a row of metal teeth dimensioned to be operatively engaged to a gear. Hand crank 6 surrounds vertical pole 8 and at its lowest position is on top of and adjacent to base 7. Hand crank 6 is well known in the machining tools art and has been used in the industry to adjust the height of a drill press. The hand crank 6 comprises a handle 10 operatively connected to internal gears (not shown). The internal gears are operatively engaged with the gear rack 12 on the vertical pole 8 as is well known in the industry. Further, as is well known in the industry, in a preferred embodiment, the internal gears include a worm gear. The worm gear prevents the gears from moving unless hand crank handle 10 is turned. A hand crank sleeve 14 surrounds a portion of the vertical pole 8 and is connected to the top of hand crank 6. Preferably, a bushing is interposed between vertical pole 8 and hand crank sleeve 14. The bushing ensures a tight fit and allows for a smoother rotating motion. Handle 10 may further fold into hand crank 6 in a locking and stored position, as is known in the art.

Referring still to FIGS. 1 and 7, an arm extends horizontally from the hand crank sleeve 14. The arm can be in any configuration that can support the weight of the accessory holder and the accessories. In one embodiment, as shown in FIG. 7, the arm comprises an upper support arm 32 and a lower support arm 34 that forms a triangular shape with the hand crank sleeve 14. Specifically, the upper support arm 32 extends horizontally from the hand crank sleeve 14 and the lower support arm 34 extends at an upward angle from the hand crank sleeve 14 at a position below the upper support arm 32. The upper support arm 32 and lower support arm 34 are connected at a distal end where they are connected to shaft sleeve 18. Shaft sleeve 18 surrounds shaft 28. Shaft 28 extends down from shaft sleeve 18 and is attached to crossbar bracket 26. A thrust bearing may be interposed between the crossbar bracket 26 and the shaft sleeve 18. The thrust bearing can be of the ball or barrel type thrust bearing or any other type of thrust bearing known in the art.

In an alternative embodiment, the accessory holder can be vertically adjusted by a gas cylinder adjustment means instead of or in conjunction with the hand crank 6. Gas cylinders provide controlled and smooth lifting assistance for height adjustment. The use of gas cylinders to vertically adjust the accessory holder according to the present invention is advantageous because various gas cylinders can be employed to make the accessory holder adaptable to a number of different devices of different weights and sizes. Various compression gas cylinders are available allowing the present invention to be customized based on the use of gas cylinders having different stroke lengths and different weight ratings.

In another alternative embodiment, the handle 10 can be replaced with a motor operatively connected to the hand crank 6. The invention would operate in the same manner as the embodiment with the handle, except that the user would just turn on the motor and the motor would rotate the gears as if the user was rotating the handle 10. Preferably, the motor could be turned on in the forward or reverse direction so that the accessory holder could be lowered or raised.

In a further alternative embodiment, hand crank 6 includes an elongated portion which forms an inner sleeve which surrounds the vertical pole 8. Sleeve 14 then surrounds and rotates around the inner sleeve. Preferably, the sleeve 14 would be supported by a thrust bearing or ball bearings at the point of contact between the bottom of the sleeve 14 and the hand crank 6.

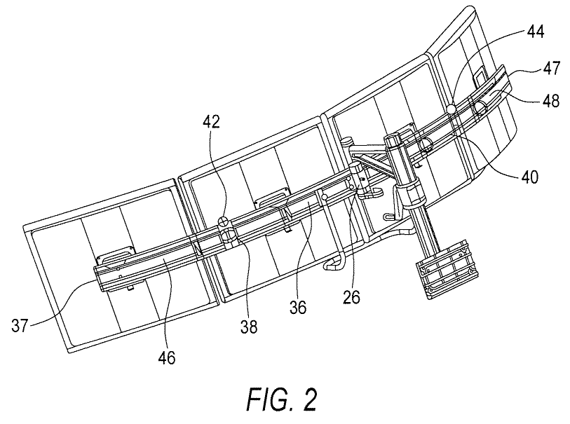

Referring to FIGS. 1 and 2, the crossbar bracket 26 is connected to the approximate center of central track 36. Central track 36 can be curvilinear or straight and preferably is rectangular in shape. The central track 36 has two distal ends 38, 40. The distal ends 38, 40 are attached to linkage mechanisms 42, 44, respectively. The linkage mechanisms are well known in the art and are essentially pivot points for movement of the wing tracks 46, 48 with respect to the central track 36. Preferably, the tracks 36, 46, 48 are curvilinear so that each of the accessories is approximately at an equal distance from the user. The user, therefore, will not need to focus and re-focus on accessories that are at varying distances. This not only saves time by not having to re-focus, but also relieves stress on the user's eyes. In addition, the user can maintain optimal sitting posture without the need to lean forward or back to view the accessory at an appropriate distance. The curvilinear track shape also allows the accessories to directly face the user. This reduces glare and improves the viewing clarity, thereby, further reducing stress on the user's eyes and body.

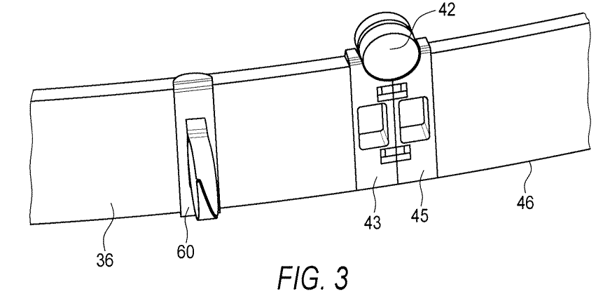

FIG. 3 shows a blown-up view of linkage mechanism 42 rotatably attaching central track 36 and wing track 46. The linkage mechanisms 42, 44 are attached to wing tracks 46, 48, respectively. The linkage mechanisms 42, 44 hold the wing tracks 46, 48 as continuous extensions of the central track 36. The wing tracks 46, 48 can be folded upward to reside on top of the central track 36 by rotating about the pivot point of linkage mechanisms 42, 44.

In an alternative embodiment, linkage mechanisms 42′, 44′ may comprise a multidirectional pivoting joint, such as a ball joint or other multidirectional pivoting joints as are known in the art. By attaching wing tracks 46, 48 with linkage mechanism 42′, 44′, wing tracks may be held as continuous extensions of the central track 36. The wing tracks 46, 48 attached by linkage mechanisms 42′, 44′ can be folded upward to reside on top of the central track 36 by rotating about one pivot point of linkage mechanisms 42′, 44′. In the alternative, wing tracks 46, 48 can be pivoted in a forward direction about another pivot point of linkage mechanisms 42′,44′ such that the wing tracks 46, 48 are held in a perpendicular position relative to the central track 36.

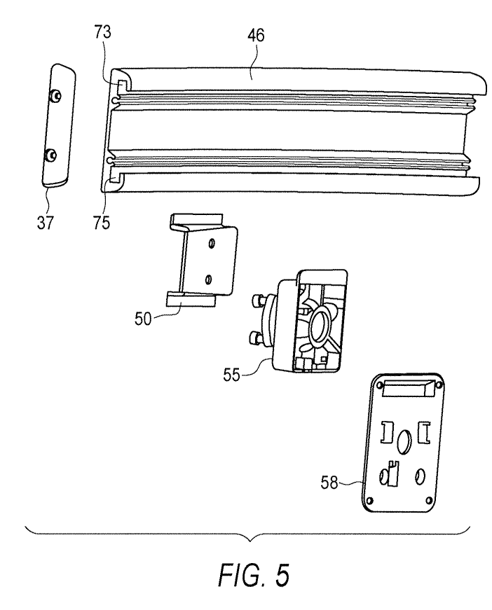

Referring to FIGS. 4 and 5, a plurality of support attachment brackets 50 can be slidably attached to the central track 36 and wing tracks 46, 48. Preferably, the tracks 36, 46, 48 have removable end caps 37, 39, 41, 43, 45, 47. The end caps can be snap fit in place and can be removed to slide out the support attachment brackets 50. In a preferred embodiment, the central track 36 has two support attachment brackets 50 and the wing tracks 46, 48 have one support attachment bracket 50 apiece. To facilitate the free movement of the support attachment brackets 50 through the tracks 36, 46, 48, the invention may use friction reducers (track glides), which fit over the outer edges of the support attachment brackets 50, acting as a buffer between the support attachment brackets 50 and the track channels 73, 75. Desirably, the track glides comprise a low friction material, or are coated with a low friction material, such as polytetrafluorethylene (PTFE), Teflon™, polyethylene, fluorinated ethylenepropylene copolymer (FEP), perfluoroalkoxy (PFA), or the like. Other methods for facilitating the movement of the support attachment brackets 50 along the track channels 73, 75 are also encompassed by the present invention. For example, the outer edges of the support attachment brackets 50 could be equipped with bearings for allowing roller movement through the track channels 73, 75. Further friction reducing agents could also be used with the various embodiments of the invention. For example, lubricants could be used in the track channels 73, 75 to further facilitate free movement of the support attachment brackets 50 along the tracks 36, 46, 48.

In operation, turning handle 10 causes the internal hand crank gears to turn and either move up or down on the gear rack 12. Thereby, moving the hand crank 6 up or down the vertical pole 8. As the hand crank 6 is moved up or down, the crossbar bracket 26 also moves up or down. This allows a user to move the entire accessory holder up or down with a single hand by simply rotating handle 10. The individual accessories can then be moved side-to-side by sliding them along the track.

In the embodiments shown in FIGS. 1, 4 and 7, a grip 22 is attached to the grip brackets 31, 33. Grip 22 is preferably a loop type metal handle. Grip brackets 31, 33 are connected to central track 36. Grip 22 provides a convenient handle for a user to adjust the position of the accessory holder. That is, the user can move the accessories forward (to be closer to a user) and rearward (to be farther away from the user).

In operation, in the embodiment of FIG. 4, a user grabs hold of grip 22 and either pulls forward or pushes rearward. The force exerted by the user will cause the hand crank sleeve 14 to rotate around the vertical pole 8 and the shaft sleeve 18 to rotate around shaft 28. This simple procedure enables different users to personalize the accessory positions quickly and easily and ensures proper sitting posture for all users.

In operation, after the user sets the height (e.g., by using the hand crank 6) and depth (e.g., by using the grip 22) of the accessory holder, the user can further adjust the position of each individual accessory to place them in an optimal position. The accessory can be adjusted side to side by sliding support bracket attachment 50 along tracks 36, 46 or 48. The user can then adjust the orientation and tilt of the accessory simply by applying pressure to the appropriate portion of the accessory. Referring to FIG. 5, the accessory mounting bracket 58 is connected to ball joint 55 and ball joint 55 is connected to support attachment bracket 50.

In a preferred embodiment according to the present invention, accessory mounting bracket 58 is VESA® compliant. The Video Electronics Standards Association (VESA®) is an organization of technology based companies proposing standards for the video electronics market. One standard for mounting attachment of video displays is the VESA® Flat Display Monitor Interface standard or VESA®FDMI™. The VESA® FDMI™ Standard defines mounting interfaces, hole patterns, and associated cable/power supply locations for LCD monitors, plasma displays and other flat panel devices. Under this standard, VESA® compliant video displays are equipped with either a 75×75 mm mounting hole pattern or a 100×100 mm mounting hole pattern. Further, VESA® compliant mounting patterns may be found on other types of devices that could also be beneficially attached to the FEA mechanism of the invention for improving ergonomy related to vertical positioning of the attached device.

The central track 36 and wing tracks 46, 48 can include cable management means 60 along their length to hold the power, data, and other cables. Preferably, the cable management means 60 comprises clips with two molded plastic arms that are connected at a common proximal point and touch each other at a distal point—forming a complete circle. The arms can be separated to insert power, data, and other cables and then the arms will return to their original shape to close the circle and hold the power, data, and other cables. The cable management means 60 are removably attached, preferably snapped into place.

Referring to FIGS. 1 and 4, an alternative embodiment that provides for a second row of accessories is shown. Shaft 29 extends upward from shaft sleeve 18 to allow for a second row of accessories to be supported. Shaft 29 is attached to crossbar bracket 27. The crossbar bracket 27 is connected to the approximate center of upper central track 61. The shaft 29 can be extended further to allow for a third, fourth, and additional rows of accessories limited only by the ability of the structure to support the additional weight. In a preferred embodiment, the accessory holder holds two rows of four accessories for a total of eight accessories.

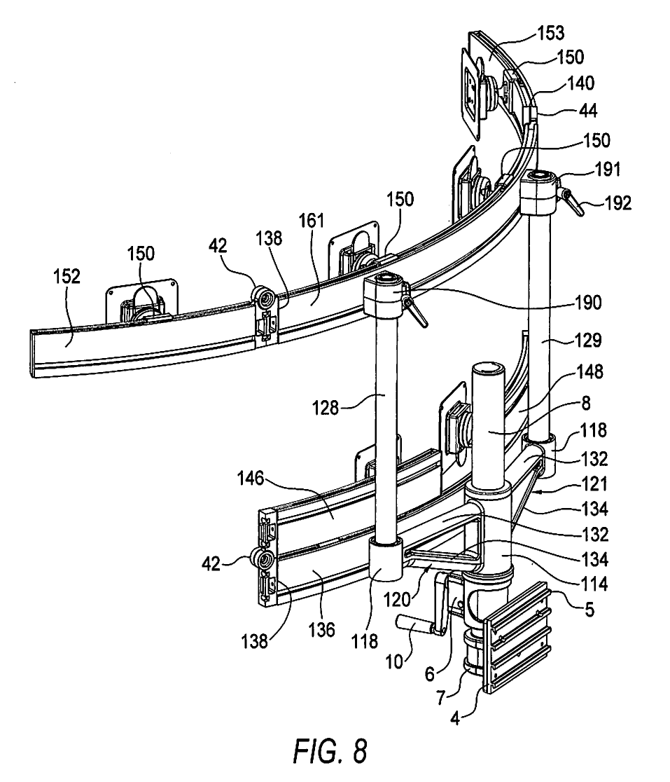

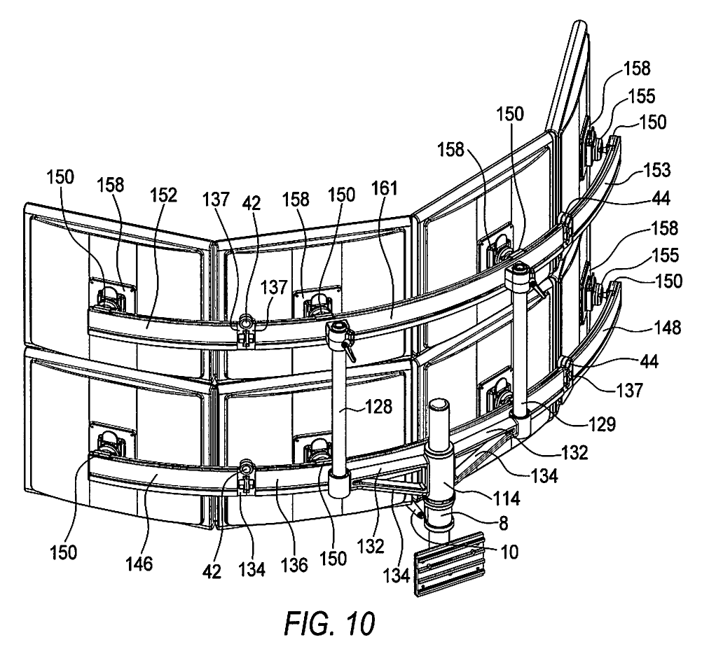

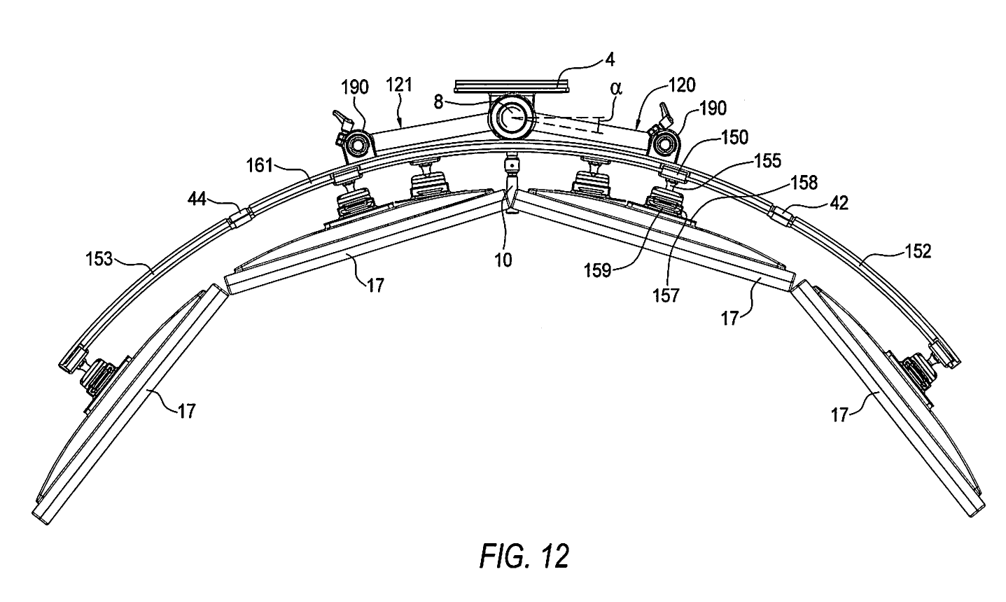

Referring now to FIGS. 8, 9 and 10, a preferred embodiment for providing two or more rows of accessories is shown. Hand crank 10, vertical pole 8, base 7, mounting plate 4 and their related accessories operate in the same manner as in the previously-described embodiments to provide a height adjustment means and a vertical support for the accessory holder. In the embodiment shown in FIGS. 8 and 10, however, instead of an arm extending frontward from the hand crank sleeve 114, as in the embodiment shown in FIGS. 1 and 7, a left support arm 120 and a right support arm 121 extend outward from the sides of hand crank sleeve 114. In order to accommodate a curvilinear track 136, the left support arm 120 and the right support arm 121 may lie within the same plane as crank sleeve 114 or may extend normally from the plane of crank sleeve 114 (as shown in FIG. 12). Preferably, the left support arm 120 and the right support arm 121 extend normally from the plane of crank sleeve 114 at an angle α of about 10 degrees such that the curvilinear nature of the track 136 may provide a curvature of about 160 degrees. Notably, in this embodiment, the grip 22 has been eliminated in exchange for the additional stability provided by left and right support arms 120, 121 and for the relative adjustment of the heights of lower track 136 and upper track 161.

Referring again to FIG. 8, the left and right support arms 120, 121 may comprise identical upper arms 132 and lower arms 134, the combination of each upper arm 132 and lower arm 134 forming a triangular shape with the hand crank sleeve 114. Specifically, the upper support arm 132 may extend horizontally from the side of hand crank sleeve 114 and the lower support arm 134 may extend at an upward angle from the side of hand crank sleeve 114 at a position below the upper support arm 132. In this embodiment, each of the upper support arms 132 and the lower support arms 134 are connected at a distal end where they are operably engaged with track 136 by any means known in the art.

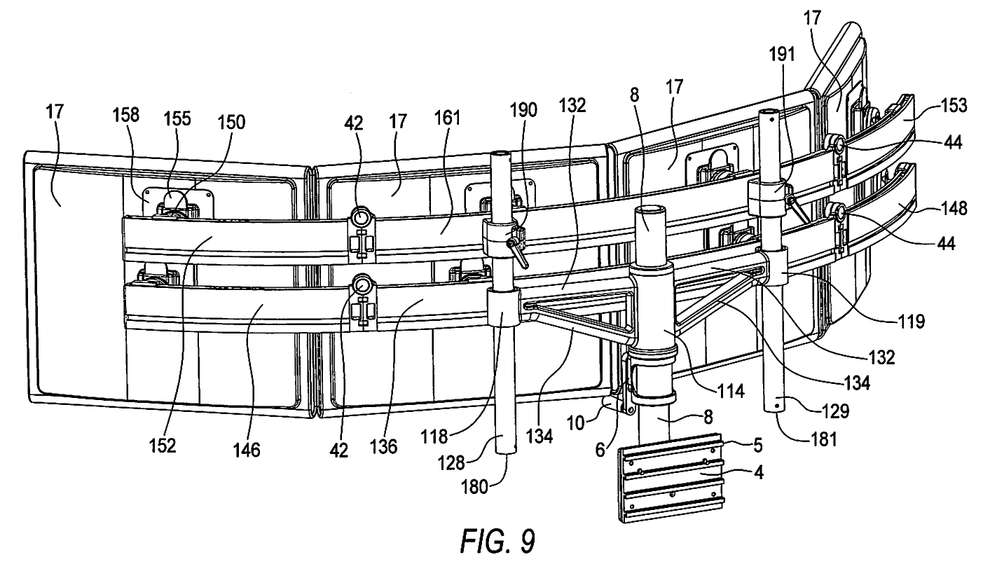

In one embodiment, as shown in FIG. 8, the track 136 is mounted to vertical shafts 128, 129 by shaft mounts attached to the track 136. In this embodiment, the shaft mount may comprise left and right shaft sleeves 118 (left), 119 (right), which are attached to track 136. Shaft sleeve 118 surrounds shaft 128 and shaft sleeve 119 surrounds shaft 129, each of shafts 128, 129 extend upward and downward from shaft sleeves 118, 119, as shown in FIGS. 8 and 9. Shafts 128, 129 may be slidably movable within shaft sleeves 118, 119 and releasably secured to shaft sleeves 118, 119, with a locking means 201, 202. In one embodiment, shaft sleeves 118, 119 may be attached to the distal ends of upper support arms 132 and lower support arms 134 as well as attached to the track 136 by brackets 123, 124. In another embodiment, shaft sleeves 118, 119 may be attached to track 136 by brackets 123, 124 at a distance outward from the operative engagement of track 136 and the distal ends of upper support arms 132 and lower support arms 134.

Upper track 161 may comprise shaft sleeves 138, 139 attached to upper track 161 at respective locations approximately equidistant from the center of track 161 such that sleeves 138, 139 are vertically aligned with sleeves 118, 119. Shaft sleeve 138 surrounds shaft 128 and shaft sleeve 139 surrounds shaft 129, each of shafts 128, 129 extend upward and downward from shaft sleeves 138, 139, as shown in FIGS. 8 and 9. Shafts 128, 129 may be slidably movable within shaft sleeves 138, 139 and releasably secured to shaft sleeves 138, 139, with locking means 201, 202. By manipulating the position of upper track 161 and lower track 136 along shafts 128, 129, by using locking means 190, 191, 201, 202, the relative positions of track 161 and track 136 may be adjusted by the user for all sizes and heights of monitors 17 or accessories as required.

Shaft mounts comprising shaft sleeves 118, 119, 138, 139, and optionally, locking means 201, 202, 190, 191, may be attached to tracks 136, 161 in any manner known in the art. Furthermore, shaft mounts may be attached to tracks 136, 161 at suitable locations for supporting the weight of multiple accessories mounted to the accessory holder of the present invention. Two shaft mounts per track are shown in the figures, along with two vertical shafts, and the shaft mounts are attached to the track 136 at a location near or equal to the attachment of the right and left support arms. One of skill in the art should appreciate, however, that the locations of attachment of the shaft mounts to the tracks 136, 161 and, thus, the locations of the vertical shafts 128, 129 may be adjusted to accommodate the mechanics of the specific application he deploys.

Locking means 201, 202, 190, 191 may comprise locking clamps with a lever 192, which may be released by the user to release locking means 201, 202, 190, 191 from shafts 128, 129 such that tracks 161, 136 may be moved to different vertical positions along shafts 128, 129, and then secured by pushing lever 192 to releasably secure sleeves 118, 119, 138, 139 of tracks 136, 161, respectively, to shafts 128, 129. One skilled in the art should appreciate that other locking means may be used to releasably secure tracks 161, 136 to shafts 128, 129 at desired vertical positions, including screw clamps, frictional locks, releasable opposing mechanisms like hook and loop fasteners, clips or otherwise, spring latches, pins, and the like. Provided the accessory holder of the present invention could be constructed for smaller accessories in a size and height that would allow one locking means per track to releasably secure the tracks 161, 136 relative to each other along vertical shafts 128, 129. Preferably, however, embodiments of the present invention may comprise one locking means per track per shaft. Moreover, in other embodiments, the two release levers on each track 136, 161 could function together, such as with a connection bar, pull wire or other connecting means.

Although the embodiment is designed to hold two or more rows of monitors 17, one skilled in the art should appreciate that a single track 136 could be mounted alone using the same arrangement of crank sleeve 114, left and right support arms 120, 121, wherein left and right support arms 120, 121 may be attached to track 136 at their distal end by any means known in the art.

Referring still to FIGS. 8 and 9, each of tracks 136, 161 have two distal ends 138, 140. The distal ends 138, 140 are attached to linkage mechanisms 42, 44, respectively. The linkage mechanisms 42, 44 are well known in the art, and are essentially pivot points for the movement of wing tracks 146, 148 with respect to the lower central track 136 and wing tracks 152, 153 with respect to the upper central track 161. Tracks 136, 161, 146, 148, 152, 153 can be curvilinear or straight, and preferably rectangular in shape. Although tracks 136, 161, 146, 148, 152, 153 may be fabricated of any type of material suitably strong enough to support the weight of accessories, preferably, tracks 136, 161, 146, 148, 152, 153 are commercially available extruded aluminum tracks curvilinear in shape such that each of the monitors 17 is at an equal distance from the user. When configured in this manner, the user does not need to focus and re-focus on monitors 17 that are of varying distances from the user's eyes. This not only saves time by not having to re-focus, but also relieves stress on the user's eyes. The user may also maintain optimal sitting posture without the need to lean forward or back to view the monitors 17 at an appropriate distance. The curvilinear track shape also allows the monitors 17 to directly face the user. This reduces glare and improves the viewing clarity, thereby further reducing stress on the user's eyes and body.

As shown in FIGS. 9, 10 and 11, a plurality of support attachment brackets 150 can be slidably attached to the lower and upper central tracks 136, 161 and wing tracks 146, 148, 152, 153. Preferably, the tracks 136, 161, 146, 148, 152, 153 have removable end caps 137 (illustrated in FIG. 3, where identical end caps 43, 45 are shown with tracks 36, 46). The end caps 137 can be snapped into place, and can be removed to slide out the support attachment brackets 150. In a preferred embodiment each of the central tracks 136, 161 have two support attachment brackets 150 and each of the wing tracks 146, 148, 152, 153 have one support attachment bracket 150.

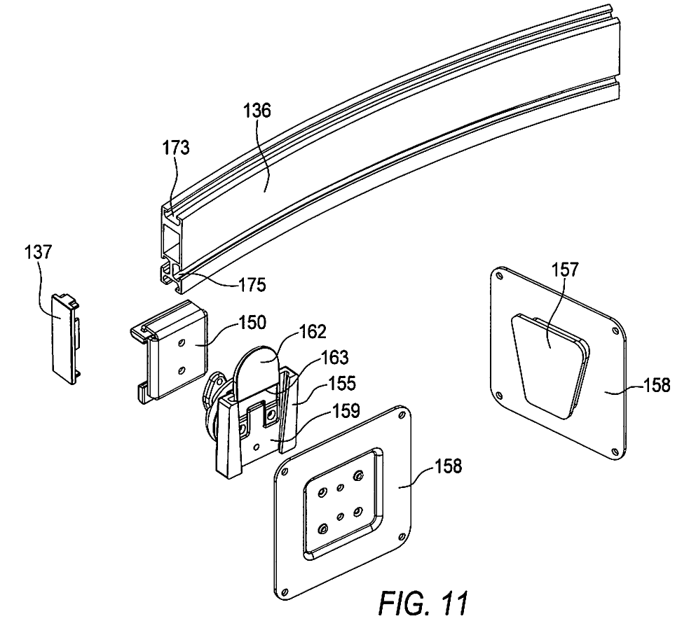

To facilitate free sliding movement of the support attachment brackets 150 through the tracks 136, 161, 146, 148, 152, 153, the invention may use friction reducers (such as track glides, ball bearing carriages, and the like), which fit over the outer edges of the support attachment brackets 150, acting as a friction reducer between the support attachment brackets 150 and the track channels 173, 175 (shown in FIG. 11). Preferably, the friction reducers comprise a low friction material, or are coated with a low friction material, such as polytetrafluorethylene (PTFE), TEFLON® (E. I. du Pont de Nemours and Co., Wilmington, Del.), ZONYL® (E. I. du Pont de Nemours and Co., Wilmington, Del.), polyethylene, fluorinated ethylenepropylene copolymer (FEP), perfluoralkoxy (PFA) or the like. Other methods for facilitating the movement of the support attachment brackets 150 along the track channels 173, 175 are also encompassed by the present invention. For example, the outer edges of the support attachment brackets 150 could be equipped with bearings for allowing roller movement through the track channels 173, 175. Further friction reducing agents could also be used with the various embodiments of the invention. For example, lubricants could be used in the track channels 173, 175 to further facilitate free movement of the support attachment brackets 150 along the tracks 136, 146, 148, 152, 153.

Referring now to FIG. 11, one side of ball joint 155 is connected to support attachment bracket 150 by any means known in the art, preferably by a means that supports the weight of a range of monitors 17 or other devices. In a preferred embodiment, the opposite side of ball joint 155 comprises a tapered slot 159 to assist with mounting a monitor 17 via accessory mounting bracket 158. One side of the accessory mounting bracket 158 comprises a tapered flange 157, which is shaped to slide into slot 159 to removable fix accessory mounting bracket 158 to ball joint 155. Tapered slot 159 may further comprise a tab 162. Tab 162 may be formed integral to the tapered slot 159 or may be formed separately. The tab 162 comprises a projection or edge 163. The edge 163 and the tab 162 may be formed such that the flange 157 slides past the edge 163 as it slides into tapered slot 159, but the edge 163 then retains flange 157 within slot 159 as the edge 163 returns to its original position. In operation, when a user presses tab 162, tab 162 releases flange 157 from tab 162, which enables a user to slide flange 157 from the tapered slot and remove the monitor 17 from the ball joint 155 and support attachment bracket 150 coupling. A U-shaped slot could be used in place of the tapered slot, as is known in the art. Generally, one skilled in the art will appreciate that any engagement allowing for a substantially flat angle, releasably secured coupling of the ball joint 155 and the support attachment bracket 150 may be utilized without departing from the present invention.

Preferably, accessory mounting bracket 158 is VESA® compliant, including compliant with the Flat Display Monitor Interface standard for mounting interfaces, hole patterns and associated cable/power supply locations for LCD monitors, plasma displays and other flat panel devices. Under this standard, VESA® complaint video displays are equipped with either a 75 mm by 75 mm mounting hole pattern or a 100 mm by 100 mm mounting hole pattern. Further, VESA® compliant mounting patterns may be found oil other devices that could also be attached to the accessory mounting bracket of the present invention.

As described above with regard to track 36, the lower and upper central tracks 136, 161 and wing tracks 146, 148, 152, 152 can include cable management means 60 along their length to hold the power, data and other cables associated with the monitors 17 or other devices, as in other embodiments of the present invention. Other variations of cable management means, as are well known in the art, may be used with the present invention in a like manner.

In operation, turning handle 10 causes the internal hand crank gears to turn and either move up or down the gear rack 12, which moves the hand crank 6 up or down the vertical pole 8. As the hand crank 6 moves up or down, the operable engagement between track 136 and the distal end of left and right support arms 120, 121 causes track 136 to move up or down. A user may move the entire accessory holder up or down with a single hand by simply rotating handle 10. The user then adjusts the relative distance between the upper track 161 and the lower track 136 by releasing locking means 201, 202 to move lower track 136 upward or downward along shafts 128, 129, re-engaging locking means 202, 202, then releasing locking means 190, 191 to move upper track 161 upward or downward along shafts 128, 129, and then re-engaging locking means 190, 191. Likewise, the lower track may be adjusted first, if preferable to the user. If the user desires to mount only one row of monitors 17 (see FIG. 9), the user can release locking means 190, 191, position upper track 161 at its lowest level adjacent to the lower track 136, and secure locking means 190, 191 to keep upper track 161 hidden behind tile monitors 17 mounted to track 136. If the user desires to mount more than one row of monitors 17, then the user can release locking means 190, 191, move track 161 or other additional tracks 161 to a desired height, and re-engage locking means 190, 191 to position upper track 161 at the desired height.

In order to mount the monitors 17, the user slides the desired number of support attachment brackets 150 into tracks 173, 175 on each of tracks 136, 146, 148, 161, 152, 153 and replace end caps 137 as needed. Then, the user affixes an accessory mounting bracket 158 to the back of each monitor 17. The user slides the tapered flange 157 on the accessory mounting bracket 158 into the tapered slot 159 of the ball joint 155. In this manner, each monitor 17 can be mounted to the accessory holder at a substantially flat angle and the engagement stably supports the weight of the monitor 17. Although the mounting mechanism has been described herein for illustrative purposes, monitor 17 or other devices may be mounted to support attachment bracket 150 in any manner known in the art. To remove the monitor in the same fashion, a user presses the tab 162 and releases the flange 157 from the slot 159, and removes the monitor at a substantially flat angle.

One skilled in the art also should appreciate that the lower ends 180, 181 of shafts 128, 129 could be fixed to shaft sleeves 118, 119, in which event larger portions of shafts 128, 129 may be visible above a mounted accessory when the upper track 161 is positioned at its lowest configuration adjacent to the lower central track 136. In other embodiments, the upper ends 182, 183 of shafts 128, 129 could be fixed to shaft sleeves 138, 139, in which event larger portions of shafts 128, 129 may be visible below a mounted accessory. Because this may be undesirable to some users who would prefer that shafts 128, 129 be hidden when using only the lower central track 160 or when using the accessory holder of the present invention for smaller monitors 17, it is preferable that the shafts 128, 129 be movable within both sleeves 118, 119, 138, 139 and locking means 201, 202, 190, 191 be used such that the heights of tracks 136, 161 are adjustable relative to each other by using hand crank 10 to adjust the height of track 136 (as described above in regard to the embodiment shown in FIG. 1) and by using the locking means 201, 202, 190, 191 to adjust the height of track 161 relative to the height of track 136 along shafts 128, 129 (compare the heights of tracks 136, 161 in FIG. 8 and FIG. 9).

In other embodiments of the present invention, shafts 128, 129 may comprise telescoping shafts, such that the distance between the upper track 161 and the lower track 136 may be shortened or lengthened in a manner that allows the user to hide the shafts 128, 129 behind the mounted accessories. One skilled in the art should appreciate that the ends of telescoping shafts may be attached to the tracks 161, 136 directly, with the vertical adjustment performed by the telescoping action of the shafts, not the slidable movement of shafts 128, 129 within sleeves 118, 119, 138, 139.

One skilled in the art also should appreciate the various configurations of upper track 161 and lower track 136 and their respective wing tracks 146, 148, 152, 153. One such configuration is shown in FIG. 8. Wings 146, 148 are rotated inward such that two monitors 17 can be supported by lower track 136, whereas wings 152, 153 are rotated outward such that four monitors 17 can be supported by upper track 161.

The accessory holder of the present invention is further adaptable to use in different settings, and with a variety of devices, in that the accessory holder can be made in a variety of lengths to provide various ranges of adjustment.

As would be readily envisioned by one of skill in the art, the various mechanisms described herein are particularly useful in combination for providing functional, attractive support mechanisms that allow for easy position adjustment of attached devices. All combinations of the multiple mechanisms described herein are therefore encompassed by the present invention.

Preferentially, the various components of the present invention are constructed generally out of a strong, lightweight material, such as aluminum. Various different materials could also be used, such as other metals or plastics. Those skilled in the art of fabrication of such accessory holders in the field of the present invention should appreciate the variety of materials suitable for the invention.

As will be appreciated by one of skill in the art, the arrangement of the accessories mounted to the present invention, whether one or multiple accessories, can be created without the addition of other components. The accessory holder of the present invention can be fully customized to any particular arrangement of accessories, including perpendicular and parallel accessories, without the user locating or installing additional parts to add more accessories in parabolic or perpendicular mounting arrangements. If the user desires to install just one accessory, then the wing tracks 46, 48 may be folded up and hidden behind the accessory. If the user desired to install eight accessories, then each of the wing tracks 46, 48 may be extended outward to mount the accessories.

Also as will be appreciated by one of skill in the art, the present invention may comprise power or data connections throughout the accessory holder 1, which receive power, data or other information from an outside source of power, data or other information, and which provide power, data or other information to any accessories mounted to the accessory holder 1. The power or data connections may be integrated into the accessory holder such that an accessory mounted to the support attachment bracket can receive, power, data or other information from the power or data connections without the user having to separately provide power, data or other information directly to the accessory. Such power and data connections are well known in the art, including power converter cables, coaxial cables, USB cables and the like. The outside sources of power, data and other information include, but are not limited to, electrical power, computers, microprocessors, electrical circuits, power converters, generators, and the like.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. An accessory holder comprising:
a. a vertical support;
b. a height adjustment means comprising a left support arm and a right support arm operatively engaged to the vertical support;
c. a first track attached to left support arm and the right support arm, the first track comprising at least two shaft mounts attached to the first track at locations approximately equidistant from the center of the first track;
d. at least two vertical shafts, each vertical shaft releasably secured to one shaft mount of the first track, and each vertical shaft capable of receiving one or more additional tracks;
e. at least one additional track comprising at least two shaft mounts, each shaft mount operatively engaged with each vertical shaft, such that the first track and the one or more additional tracks are capable of relative height adjustment; and
f. at least one support attachment bracket slidably attached to the track;
the support attachment bracket being adapted to removably attach to an accessory.

2. The accessory holder of claim 1, wherein the vertical support further comprises a mounting means.

3. The accessory holder of claim 1, wherein the height adjustment means further comprises a height controller; wherein the left support arm and the right support arm each extend outward from the vertical support and are attached to the track, and wherein the height of the left and right support arms is controlled by the height controller.

4. The accessory holder of claim 3, wherein the height adjustment means further comprises a sleeve surrounding the vertical support, the sleeve being capable of rotating around the vertical support, the sleeve being operably engaged to the height controller.

5. The accessory holder of claim 4, wherein the left and right support arms each comprise an upper arm extending substantially horizontally from the sleeve to a distal end; and a lower arm extending from the sleeve at an upward angle to an intersection with the upper arm.

6. The accessory holder of claim 5, wherein one of the shaft mounts attached to the first track is attached to the intersection of the lower arm and the distal end of the upper arm of the left support arm and another shaft mount attached to the first track is attached to the intersection of the lower arm and the distal end of the upper arm of the right support arm.

7. The accessory holder of claim 5, wherein the first track is attached to the intersection of the upper arm and the lower arm of the right support arm separate from a shaft mount of the first track, and the first track is attached to the intersection of the upper arm and the lower arm of the left support arm separate from a shaft mount of the first track.

8. The accessory holder of claim 1, wherein the first track comprises:
a. a central track attached to the height adjustment means; and
b. at least one wing track pivotally attached to a distal end of the central track.

9. The accessory holder of claim 8, wherein the wing track is pivotally attached to a distal end of the central track such that the wing track pivots up to 180 degrees in the same plane as the central track.

10. The accessory holder of claim 8, wherein the wing track is pivotally attached to a distal end of the central track such that the wing track pivots up to 90 degrees in a plane perpendicular to the central track.

11. The accessory holder of claim 1 further comprising one or more power or data connections that engage the support attachment bracket and an outside source of power or data, such that the connections are adapted to provide power or data to the accessory.

12. The accessory holder of claim 1, wherein the shaft mount comprises a shaft sleeve attached at the intersection of the tipper arm and the lower arm of each of the left support arm and the right support arm.

13. The accessory holder of claim 12, wherein shaft mount further comprises a shaft sleeve and a locking means for adjusting the relative height between the first track and the one or more additional tracks, the vertical shafts being operatively engaged within the shaft sleeve and relesably secured to the shaft sleeve by the locking means.

14. The accessory holder of claim 3, wherein the height controller comprises:
a. a gear rack attached to the vertical support;
b. at least one gear operatively engaged with the gear rack; and
c. a handle attached to the at least one gear, wherein rotating the handle rotates the at least one gear.

15. The accessory holder of claim 3, wherein the height controller comprises:
a. a gear rack attached to the vertical support;
b. at least one gear operatively engaged with the gear rack; and
c. a motor attached to the at least one gear, wherein rotating the motor rotates the at least one gear.

16. The accessory holder of claim 3, wherein the height controller comprises:
a. a housing supporting a gear rack along its length;
b. a skate slidably attached to the housing;
c. at least one gas cylinder attached to the skate;
d. at least one gas cylinder actuator attached to the at least one gas cylinder;
e. a gear box having at least one gear operatively engaged to the gear rack, the gear box attached to the skate; and
f. a knob attached to the at least one gear.

17. The accessory holder of claim 2, wherein the mounting means comprises a wall mount, the wall mount having a plate through which mechanical fasteners can be inserted into a wall.

18. The accessory holder of claim 2, wherein the mounting means comprises:
a. a receiving member attached to a desk and adapted to receive a connecting member; and
b. a connecting member attached to the height adjustment means.

19. The accessory holder of claim 2, wherein the mounting means comprises a mounting plate attached to the vertical support and a wall track attached to a wall, the wall track adapted to be removably attached to the mounting plate.

20. The accessory holder of claim 2, wherein the mounting means comprises a desk mount, the desk mount comprising:
a. a desktop;
b. a receiving member attached to the desk and adapted to receive a connecting member; and
c. a connecting member attached to the height adjustment means.

21. An accessory holder comprising:
a. a mount adapted for attachment to a structure;
b. a base attached to the mount;
c. a substantially circular cylinder comprising a distal end and a proximal end, the circular cylinder attached to the base at the proximal end;
d. a gear rack along the vertical length of the substantially circular cylinder;
e. a hand crank housing movably attached to the substantially circular cylinder;
f. a gear movably attached to the hand crank housing and operably engaged with the gear rack;
g. a handle attached to the gear;
h. two support arms each comprising a distal end and a proximal end, each support arm attached at a proximal end to the substantially circular cylinder extending outward from the substantially circular cylinder;
i. a central track comprising two distal ends, the central track attached to the distal ends of the support arms, the central track being curvilinear, the central track further comprising at least two shaft mounts;
j. at least one wing track pivotally attached to a distal end of the central track;
k. at least two vertical shafts, each vertical shaft being operatively engaged through each shaft mount;
l. one or more additional tracks, each additional track comprising at least two shaft mounts operatively engaged with the at least two vertical shafts; and
m. at least one support attachment bracket adapted to be removably attached to an accessory, the support attachment bracket slidably attached to one of the central track and the wing track.

22. The accessory holder of claim 21, wherein the wing track is pivotally attached to a distal end of the central track such that the wing track pivots up to 180 degrees in the same plane as the central track.

23. The accessory holder of claim 21, wherein the wing track is pivotally attached to a distal end of the central track such that the wing track pivots up to 90 degrees in a plane perpendicular to the central track.

24. The accessory holder of claim 21 further comprising one or more power or data connections that engage the support attachment bracket and an outside source of power or data, such that the connections are adapted to provide power or data to the accessory.

25. The accessory holder of claim 21, wherein each of the shaft mounts comprises a locking means releasably securing the vertical shaft to the shaft mount, such that the relative distance between the one or more additional tracks and the central track may be adjusted by a user by securing the tracks along the vertical shafts at desired heights.

26. An accessory holder comprising:
a. a vertical support;
b. a height adjustment means comprising a left support arm and a right support arm operatively engaged to the vertical support;
c. at least one track attached to left support arm and the right support arm;
d. at least two vertical shafts operatively engaged with the track and capable of supporting one or more additional tracks in operative engagement with the vertical shafts such that the relative height between the track and the one or more additional tracks may be adjusted along the vertical shafts; and
e. at least one support attachment bracket slidably attached to the track;
the support attachment bracket being adapted to removably attach to an accessory;
wherein each of the vertical support, the left support arm, the right support arm, the track, and the support attachment bracket are operably engaged when in use.
